(19) United States
(12) Patent Application Publication
(10) Pub. No.: US 2004/0236463 A1
(43) Pub. Date: Nov. 25, 2004

(54) Compound storage system

(75) Inventors: Mark Weselak, San Diego, CA (US); Kristina Burow, Chicago, IL (US)

Correspondence Address: QUINE INTELLECTUAL PROPERTY LAW GROUP, P.C., P O BOX 458, ALAMEDA, CA, 94501, US

(73) Assignee: IRM, LLC, Hamilton (BM)

(21) Appl. No.: 10/773,766

(22) Filed: Feb. 6, 2004

Related U.S. Application Data
(60) Provisional application No. 60/445,626, filed on Feb. 7, 2003.

(51) Int. Cl. G06F 7/00

(52) U.S. Cl. 700/214

(57) ABSTRACT

This invention provides a storage system and methods to accurately transfer of compounds between storage modules and work areas. The system for compound storage and retrieval provides a computer system operatively coupled to the storage modules to implement transfer operations. Methods can include redundant access and identification procedures to reduce errors in storage and retrieval of compounds.

### CROSS-REFERENCE TO RELATED APPLICATIONS

This application claims priority to and benefit of a prior U.S. Provisional Application No. 60/445,626, “Compound Storage System”, by Mark Weselak, et al., filed Feb. 7, 2003. The full disclosure of the prior application is incorporated herein by reference.

### FIELD OF THE INVENTION

This invention is in the field of automated sample storage and retrieval systems. The present invention relates to, e.g., a system of work areas, computers and storage hardware to efficiently manage large sample sets in cold, e.g., frozen storage. The systems of the invention can include, e.g., databases to document and logically direct transfer of inventories with efficiency and reduced error.

### BACKGROUND OF THE INVENTION

High throughput (HTP) screening and analysis of samples has become an increasingly important aspect of research in medicine and biotechnology. Genome sequencing projects continue to publish nucleic acid sequences suggesting millions of possible targets and probes for use in medicine, agriculture and industry. Chemists have produced huge libraries of small molecules and peptides to be screened in studies of receptor binding, modulation of signal transduction, antimicrobial effects, and the like. As sophisticated as computerized and robotic HTP screening methods are, they require equally sophisticated methods and systems for sample handling and inventory control. The quality of sample sets and molecular libraries depends heavily on the reliability of sample handling, conditions of storage, and the accuracy of inventories.

Current automated sample handling systems can reduce errors but may not function well in certain harsh storage environments. Available automated storage systems, do not specify operation in environments below about −20° C. At colder temperatures, reliability of automated motions drops drastically while maintenance costs increase.

Current systems that rely solely on human technicians to handle samples are prone to a high error rate in sample retrieval and storage. For example, a manual sample retrieval operation might include the steps of determining the location of the samples from a computer or paper file, searching for boxes of samples in various freezers, removing samples from the boxes, documenting inventory changes in the file, and returning the boxes to the freezers. During such a process, inventory and tracking errors can accumulate as boxes are rearranged during the search, as multiple boxes retrieved are not returned to the same positions in the freezers, and as technicians fail to accurately document changes to the inventory. Initial errors tend to foster additional errors in later retrieval operations.

Conditions of storage are critical to the stability of samples in storage. In general, chemical and biological samples are more stable in sealed containers consistently maintained in inert atmospheres at very cold temperatures. Many current manual sample storage systems fail to provide consistent storage temperatures, storage gasses, or storage humidity. Systems reliant on human technicians often have long cycle times in sample handling with storage doors open while samples are located, removed and replaced. Storage doors remain open longer when the location of samples is not clearly designated. The result can be shortened sample storage life, oxidative degradation of samples, and icing of the storage area surfaces. In addition, failure to monitor the temperature, oxygen potential or relative humidity of storage areas in some systems can allow problems to go unnoticed and uncorrected.

Problems with sample handling, storage conditions, and inventory control tend to be compounded and can result in failure of the entire sample storage system. Errors in handling lead to problems with the inventory database. Errors in the inventory lead to long handling cycle times causing inconsistent storage conditions and icing. Thus, a reliable automated system to control sample handling, the storage environment, and inventory documentation will be of significant scientific and commercial importance.

In view of the above, a need exists systems for rapid, accurate, reliable, and well documented sample handling, particularly for samples in cold storage below −20° C. It would be desirable to automate aspects of freezer sample storage and retrieval steps, for controlled work flow, and accurate documentation of inventories. Benefits can be derived from improving work areas to enhance efficiency of handling large numbers of samples while reducing problems inherent in retrieving and storing samples at very low temperatures. The present invention provides these and other features that will be apparent upon review of the following.

### SUMMARY OF THE INVENTION

The compound storage system of the invention includes hardware and practices to maintain an accurate inventory of samples. The storage system includes, e.g., a temperature controlled storage module which can be made up of racks with slots in rows and columns to receive trays holding plates with wells filled with samples. The location of any sample can be uniquely identified, e.g., according to the module number, row and column tray location, plate number, and row and column sample well location. A redundant system including, e.g., door locks, tray location indicator lights, color coding, and confirmatory scanning procedures can prevent errors in tray loading. A computer system plate database can, e.g., track the location of all samples and can be updated in near real time with each tray transfer operation. The computer can regulate access to samples by controlling storage module door locks and can direct an operator to the correct tray locations by energizing LED tray location indicators. Reliability for very cold storage applications is increased in this invention by preventing icing conditions and by minimizing mechanical components.

The invention provides a compound storage and retrieval system including a work area, storage modules and a computer system. The work area provides operator access to the storage modules. The storage modules can have lockable doors for access to racks which have slots to receive trays. The computer system can have programs to implement tray transfer operations and can be operably coupled to communicate with the storage modules, e.g., through an interface circuit.

To prevent icing in the storage module, the storage system can have a cold work area with low relative humidity, e.g., less than 40% relative humidity at 1 to 8° C. Low icing conditions in the work area can be maintained in part by providing human operator access to the work area through a 4° C. to 20° C. low relative humidity antechamber.

The storage modules of the invention can include, e.g., a refrigeration system for temperature control, a lockable door, and/or storage racks with tray location indicators. The storage modules in the invention can have interior storage temperatures controlled at settings of, e.g., −20° C. or less, or between −20° C. and −55° C., or less than −55° C., with a precision of, e.g., plus or minus 2° C. The storage module can have a transparent door with a lock controlled by commands transmitted from the computer. The lock can be a magnetic lock with a locking force of, e.g., 100 pounds or more. The door can be opened sufficiently to allow uninhibited removal of storage racks from the storage module.

The racks of the invention can have slots defining tray locations which can be arranged in rows and columns to receive trays. The number and orientation of slots can vary with applications. In one embodiment, each storage module contains 100 or more slots, 100 to 300 slots, or more. In another embodiment, the slots are arranged in 10, 30, 50 or more rows with 4, 5, 6 or more columns. The slots can slidably receive trays on lengthwise rails which can be thin to minimize contact surfaces. The racks can have bar-coded labels at each slot to identify tray locations. Because the bar-coded labels can be located on the rack between rows or columns of slots, ambiguity of tray locations can be eliminated by labeling each slot with unique bar code labels on two or more sides. Tray location indicators can be placed on the rack, in association with slots. Commands can be transmitted from the computer to direct actuation of the tray location indicators to direct an operator to a tray location of interest. In one configuration of the invention, tray location indicators are, e.g., light emitting diodes (LEDs), a light, a buzzer, a flag, and/or a alphanumeric indicator, associated with each slot, e.g., on the rack on each side of each slot.

In an aspect of the invention, trays can be adapted to receive containers, e.g., a tube, a bottle, a vial, a culture dish or a microtiter plate. The microtiter plates can be, e.g., 96-well plates, 384-well plates and/or 1536-well plates. The microtiter plates or containers can each have a unique bar code. The microtiter plates or other containers can be sealed to prevent drying or cross contamination. The trays can each have, e.g., 2 to 12 nests, each nest capable of holding, e.g., one deep well microtiter plate, three standard microplates, or four shallow microplates. The trays can be fabricated from any durable material adapted to the storage conditions such as, e.g., stainless steel or polycarbonate. The trays of the invention can be labeled for identification with, e.g., bar code labels, alphanumeric labels with tray information, and/or labels color coded with unique colors corresponding to a particular column or row. Color coded labels can have a single color or combination of colors to indicate tray information. The trays of the invention can have handles at each end for manual transport. The containers of the invention can hold a large number of compounds, e.g., chemical or biochemical compounds, nucleic acids, peptides, polypeptides, proteins, carbohydrates, cells, serum, phage particles, virions, enzymes, cell extracts, lipids, antibodies, and/or synthetically modified peptides. The containers of the invention, e.g., microtiter plates, can hold the compounds as members of libraries stored in the compound storage and retrieval system.

A computer system having one or more data input source, data storage location, and data output device is an aspect of the invention. Data input sources can include, e.g., a bar code reader, an operator input device, or other devices transmitting, e.g., work area temperature data, storage module temperature data, work area oxygen data, and/or storage module oxygen data to the computer. A plate database in the data storage location is a feature of the invention. Data output devices, e.g., digital readouts or computer monitors, of the invention can display, e.g., work area temperature data, storage module temperature data, work area oxygen levels, storage module oxygen levels, and/or instructions for operators.

A useful embodiment of the invention includes a compound storage module, temperature controlled at a temperature setting from about −20° C. to −55° C., with transparent lockable doors controlling access to the rack modules. The rack modules of this embodiment have slots arranged in rows and columns with tray location indicators attached to the rack in association with each slot.

In a preferred embodiment, the computer system has a plate database containing plate and sample information such as, e.g., library names, sub-group descriptions, mother/daughter plate designations, plate types, plate creation dates, plate locations, compound structures for each well, and/or volumes for each well. In one embodiment, the plate location is designated by a tray location. The database can include a consistently updated mother plate history with plate activity dates, volumes removed per sample, and volumes remaining per sample; such data can be updated for each operation of preparing daughter plates from the mother plates.

The invention additionally provides a method of retrieving and storing compounds, including, e.g., the steps of identifying a tray location for a requested tray in a storage module, designation of the tray location, directing unlocking of the storage module door, confirmation of the tray identity on retrieval of the requested tray, and confirmation of the tray identity and the tray location on reloading of the tray. The method of retrieving and storing compounds can be facilitated by using a computer system. Tray locations can be identified, e.g., by comparing an operator plate request with a plate database. Tray locations can be designated, e.g., by a computer command directing actuation of tray location indicators at the tray location. Unlocking a door controlling access to the storage module can be directed, e.g., by a computer command terminating actuation of the door lock. Tray identity on retrieval can be confirmed, e.g., by scanning the bar code on the retrieved tray into the computer for comparison to the requested tray identification for confirmation the correct tray has been retrieved. After reloading of the tray to the correct location is confirmed, e.g., by scanning the bar code on the reloaded tray and scanning bar codes at the tray location into the computer to confirm the reloaded tray is in the correct slot, actuation of the tray location indicator can be cancelled. A feature of the invention is to repeat the entire method of retrieving and storing compounds for additional requested trays until all trays required to obtain every requested sample have been made available to an operator.

One feature of the invention is a method of controlling lockable doors to storage modules. The intent is to unlock the doors only as required for tray retrieval or reloading and to allow only one tray to be removed at a time from each storage module. This strict process can prevent mixing of trays into the wrong storage modules and slots. For example, when a tray location is designated during a retrieval operation, a computer command can direct unlocking the door controlling access to the storage module associated with the tray location only if all slots in the storage module contain a tray. A computer command then directs locking the door after a tray has been removed and identified (confirmation of tray retrieval). Then, a computer command directs unlocking of the door after a request to reload the tray. Finally, on confirmation of tray identity and the correct tray location after reloading of the tray, a computer command directs locking of the door. The door does not have to be closed during the locking command but the lock mechanism can be configured, e.g., as a magnetic lock or a lock with a spring loaded latch, such that the door will not reopen after it has been closed by an operator.

In order to maintain a current and accurate inventory of trays, plates and samples, it is an aspect of the invention to update the plate database to reflect any changes in associated plate data concurrent with the tray being retrieved from the tray location. Database updates can be accomplished, e.g., by bar code scanning of plates added or removed from the tray, or by direct data input by an operator. In one embodiment, the computer system will suspend a command for unlocking an associated storage module door until a plate database is updated with any changes to samples or plates in a tray, thus providing a database current to the most recent sample transfer.

A useful method for controlling sample retrieval and storage can comprise, e.g., inputting a request for a sample to be retrieved from a storage module, identifying a tray location in the storage module by searching a plate database in a computer for the plate location of the requested plate, designating the tray location with a computer command directing actuation of a tray location indicator at a location associated with the tray location, directing unlocking a door controlling access to the storage module associated with the designated tray location, confirming the tray identity on retrieval of the tray by scanning a bar code on the tray, updating the plate database to reflect any changes in associated plate data while the tray is retrieved from the tray location, and confirming the tray identity and the tray location on reloading by scanning a bar code on the tray and scanning bar codes at with the tray location.

A feature of the invention is storage containers holding a variety of compounds, e.g., microwell plates, in the compound storage and retrieval system. The compounds can be, e.g., chemical compounds, biochemical compounds, nucleic acids, peptides, polypeptides, proteins, carbohydrates, cells, serum, phage particles, virions, enzymes, cell extracts, lipids, antibodies, and/or synthetically modified peptides. The compound storage and retrieval system allows efficient and error free storage and retrieval of samples from large compound libraries.

### DEFINITIONS

The term relative humidity means the percent water saturation of air, e.g., the water vapor pressure in air at a given temperature over what the water vapor pressure would be in air saturated with water at the given temperature, all times 100. The term humidity means the absolute amount of water per unit of air, e.g., grams of water per cubic meter of air.

### BRIEF DESCRIPTION OF THE DRAWINGS

FIG. 1 is a schematic diagram of an exemplary compound storage and retrieval system floor plan.

FIG. 2 is a schematic front view of a storage module with a rack having slots in rows and columns.

FIG. 3A is a schematic diagram top view of a tray having container positions, and FIG. 3B is an end view showing alphanumeric and bar code tray labels.

FIG. 4 is a representative flow diagram of compound storage procedures and a parallel computerized data tracking scheme for a compound storage and retrieval system.

### DETAILED DESCRIPTION

The present invention provides systems and methods for storage and retrieval of compound sample sets. The invention is intended to maximize system reliability by minimizing moving parts and by reducing the possibility of icing in cold storage environments. The invention is also intended to reduce inventory errors by, e.g., logical identification and designation of correct tray locations, and/or by systematic control of tray transfer operations.

The compound retrieval and storage system of the invention includes, e.g., a work area, storage modules, and a computer system. An aspect of the invention is a work area with a low relative humidity and low temperature so that deposition of condensation inside storage modules or onto samples is reduced during sample retrieval operations. Another aspect is redundant tray identification and tray location identification systems in the storage modules to prevent errors during sample retrieval and storage. In one embodiment, the computer system can prevent mix up of samples by denying access to retrieve additional sample trays from a storage module which already has a tray removed. In another embodiment, the computer system can deny access to return a tray to a storage module if the operator has not documented changes to the inventory while the tray was removed. The work area, storage modules and computer system can work together to protect the samples and the accuracy of the inventory.

Moving parts are minimized in cold storage areas of the invention by simplifying hardware design. It is a feature of the invention to employ simple mechanical components, such as, e.g., door hinges, door latches, tray handles, and slot tray rails, exposed to harsh storage environments. Such components are generally resistant to the effects of cold because they, e.g., do not require tight tolerances, are not made up of flexible parts, and have no electrical parts to short circuit.

The number of moving mechanical parts can be reduced in cold storage areas of the invention by, e.g., using human operators to carry out mechanical sample handling operations. For example, motorized doors and robotic arms can be avoided by having samples removed from storage modules by human operators. Sample identification and designation systems (described below) speed the manual operations to minimize operator discomfort. Optionally, complex mechanized equipment can be employed with high reliability due to the stable environments of controlled temperature and humidity afforded, e.g., in the work areas of the invention.

Inventory errors are reduced by redundant systems identifying samples and/or designating storage locations. In one embodiment of the invention, the storage modules have locking transparent doors through which racks can be viewed. The racks can have slots to receive sample trays. The slots can be designated by tray location indicators such as, light emitting diodes (LEDs), a light, a buzzer, a flag, or an alphanumeric indicator, on the rack adjacent to each slot to direct an operator to a sample tray location. Slots can also be identified by column/row position in the rack, by alphanumeric labels on the rack, bar code labels on the rack, and/or the like. Trays can be identified, e.g., with bar code labels, alphanumeric labels, color coded labels, by column/row position, and/or the like. In one embodiment of the invention, a color coded tray, identified with alphanumeric and bar code labels, is stored in a similarly color coded slot at a tray location labeled with a bar code and designated with LED tray location indicators.

The system can prevent errors by disabling inappropriate operator actions. It is a feature of the invention that a computer system can control locks on doors of the storage modules. The operator can be prevented from opening a storage module, e.g., before a request has been made for a tray that is in that particular storage module, before an operator updates changes to the inventory while a tray has been retrieved from the storage module, before a request has been made to reload a tray to the correct storage module, and/or the like.

The system can speed and improve the reliability of tray transfer operations by helping direct operator actions. For example, the computer system can actuate a tray location indicator, such as a LED, to designate the tray location of the requested tray. The operator can see the LED shining through the transparent storage module door to readily retrieve the requested tray. In one embodiment, every slot in a rack contains a tray, even if the tray is empty, so that the operator can tell if another tray has already been retrieved from the module. Having a tray, or space keeper, in every slot can also prevent an operator from accidentally replacing a tray in an incorrect slot. In such a case, the speed and reliability of tray reloading is enhanced by use of location indicators, the full slots rule, and/or a single tray retrieval rule.

Inventory errors are reduced in the invention by using operational procedures designed to minimize the chance of mixing up samples. For example, tray transfer operations can include the one or all of following conditions, rules, or procedures to prevent handling and inventory errors: 1) maintaining a database of sample identities and locations for reference in tray transfer operations; 2) requiring that no more than one tray be removed from a storage module at a time; 3) computer confirmation that all slots of a storage module contain a tray before designating a tray or unlocking the storage module door for tray retrieval by an operator; 4) computer designation of tray locations by actuation of tray location indicators to direct operators to a correct tray location; 5) operator scanning of a bar code on the retrieved tray to confirm the correct tray has been selected; 6) computer output of an error message if the retrieved tray is not the correct tray; 7) operator updating of a plate database to document the changes to in the inventory before making additional changes; 8) the computer unlocking the storage module door for tray retrieval only after a plate database has been updated for changes to the previous tray; 9) the operator scanning bar codes on the tray and at the tray location to confirm the tray is replaced to the correct tray location.

Environmental Control

Aspects of the invention are facilities and procedures to control environmental conditions. Such control is important to the stability and easy handling of samples in storage.

Icing in the storage modules can result when humid air enters the open door during tray transfer operations. Ice forming on the door can prevent it from sealing well. Ice deposited on the surface of a transparent storage module door can prevent an operator from seeing tray identification labels and tray location indicators. Ice deposited on trays can freeze them into their slots. These problems associated with icing can degrade sample identification and handling efficiency.

Humidity in the storage environment can be detrimental to the stability of compounds in storage. Degradation mechanisms of organic compounds, e.g., hydrolysis, are accelerated in the presence of water. Water can alter the character of lyophilized compositions. Control of water in the storage environment is important to preserve compounds for consistent controls and repeat analyses over time.

Relative humidity is the percent water saturation of air at a particular temperature. That is, the relative humidity of air is the ratio (expressed as percent) of the actual water vapor pressure over the water vapor pressure of the air if it were saturated at the same temperature.

Air can hold more water at a high temperature than at a low temperature. For example, air at 30° C. can hold approximately 30 grams of water per cubic meter, whereas at 20° C. air can hold only about 17 grams of water. Therefore, a cubic meter of saturated air at 30° C. would have to lose 13 grams of water on cooling to 20° C. Water lost from chilled air is commonly observed as the phenomena of rain, fog, dew, and frost. By providing work and storage environments with low relative humidity, the invention avoids deposition of dew and frost on samples and storage surfaces. In the present invention, low relative humidity is a humidity not conducive to precipitation of water onto storage module surfaces. For example, 60 percent relative humidity in the work area, is generally low enough to prevent deposits of frost unto trays or racks in a −20° C. storage module. Storage modules can be made frost free by providing a low relative humidity among the racks and trays.

Storage temperatures are critical to preserving compounds in storage. Reactions, including chemical degradation, are generally slower at low temperatures. It is an aspect of the invention to provide storage temperatures of less than −20° C. Storage temperatures of about −30° C. or less have the benefit of being below the glass transition temperatures of many sugar and salt solutions to provide glassified compositions that are generally more stable than partially frozen liquid compositions. The compound storage and retrieval system of the invention is capable of operating at temperatures as low as −55° C. to provide excellent stability for most compounds in storage. With provision of special low temperature components appreciated by those skilled in the art, the system can operate at temperatures, e.g., colder than −55° C.

Commonly available refrigeration systems can provide the temperature and humidity controlled environments of the invention. Refrigerator systems are generally made up of a compressor, a condenser, an expansion valve and an evaporator. A refrigerant gas, e.g., Freon™ or ammonia gas, is compressed by the compressor and cooled in the condenser to change state from gas phase to liquid phase. A significant amount of latent heat is given off during the change of state from gas to liquid. The liquid phase refrigerant is metered on demand by the expansion valve to be released into the evaporator. The liquid refrigerant can easily evaporate back to the gas phase in the low pressure conditions of evaporator. A significant amount of latent heat is taken in during the change of state from liquid to gas, thus cooling the evaporator. Air can be cooled by passing it over the cold evaporator.

A refrigeration system can also act as a dehumidifier. As warm air passes over a cold evaporator it loses some capacity to hold water. If the warm air is humid, some water can be removed as the air cools on passing over the cold evaporator. The humidity of the air has changed such that condensation will not occur the next time it contacts a similarly cold surface. In this way, humidity controlled air of the invention reduces water condensation and frost on cold samples and surfaces. Humidity controlled air can remove water from surfaces by evaporation and/or sublimation.

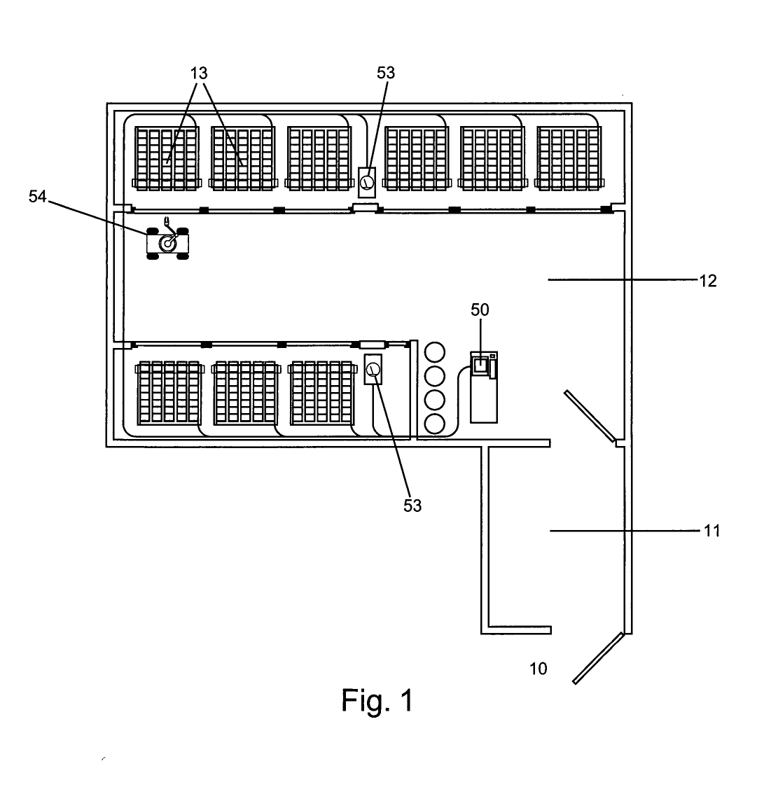

A feature of the invention is stepped control of temperature and humidity in compartmentalized work and storage areas, as shown in FIG. 1. The temperature and humidity go down, e.g., as one moves from the outside 10, to an antechamber 11, to a work area 12, to a storage module 13. The ambient temperatures outside the compound storage and retrieval system can vary widely depending on the climate and season of the locale, e.g., 37° C. to −20° C. and 20% to 100% relative humidity. Operators can enter the work area from the outside through an antechamber having a low humidity and a temperatures of, e.g., 20° C. to 0° C. Antechamber doors open to a work area, where operators handle samples in a low humidity environment at temperatures of, e.g., 8° C. to −20° C. Finally, the environment inside of storage modules can be maintained at low relative humidity levels, e.g., less than 60%, and cold temperatures, e.g., −20° C. to −55° C., and colder. By maintaining a low relative humidity in each compartment, condensation can be minimized should air from a warmer compartment enter the next colder compartment.

By dropping temperatures incrementally from the outside to the antechamber to the work area to the storage module, the air handling systems can provide more constant temperatures in each compartment. If an operator in a 17° C. work area opened the door to a storage module at −55° C., the storage temperature and humidity would change significantly and suddenly. If the door were held open for any length of time, the temperature inside the storage module could change dramatically and take a significant amount of time to recover the set temperature. Access to a −55° C. storage module from a −20° C. work area of the invention can avoid large temperature fluctuations and long temperature recovery times.

The compartments of the invention, e.g., antechamber, work area, storage module, can provide steps of dropping humidity to protect the storage environment. If access to a −55° C. storage module were from a room having an ambient temperature of 17° C. and a relative humidity of 80%, large amounts of frost would accumulate every time the storage module door was opened. In addition, an operator would not be able to see trays through a transparent storage module door because of dew and frost deposits on the outside of the door. Should work area air at −20° C. and 40% relative humidity contact the −55° C. storage module surfaces, frost deposition would be minimal. A low relative humidity within the storage module could remove any such deposits, e.g., providing a frost free environment.

Storage Modules

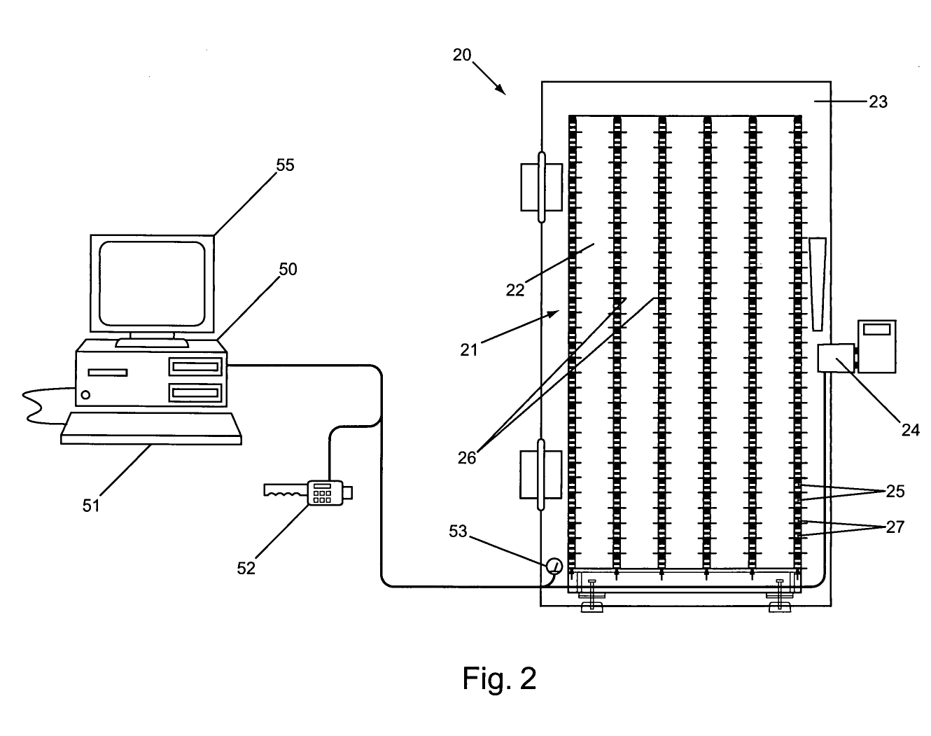

Storage modules of the invention are designed to provide stable environmental conditions for samples in storage and to minimize errors in tray retrieval and storage. Storage modules can include a series of progressively smaller components that can uniquely identify sample locations. For example, as shown in FIG. 2, a storage module 20 can comprise racks 21, with rows and columns of slots 22 for holding trays 30 with multiple container positions.

Storage modules of the invention have at least one door 23 which can control access to the module. The door can be locked to provide security against intrusion by unauthorized personnel. More importantly, storage module doors can be lockable to work in concert with the logic and methods of the invention to reduce tray transfer errors. A lock 24 on a storage module door can be computer controlled to prevent access, e.g., when no request has been made to retrieve or reload a sample tray, when a request has been made to retrieve a tray but another tray has already been removed from the module, when a request is made to reload a tray but a plate database has not been updated with changes to the tray while it was out, and/or the like. The door locks can be, e.g., magnetic, spring loaded, or solenoid actuated locks, under the control of a computer system by actuation and/or de-energization. Such locks can be configured to a locking orientation while the door is open but prevent the door from reopening after it has been closed by an operator.

Storage module doors of the invention can be designed to seal the module from the work area environment. The door of the invention can have thermal insulating qualities to reduce conduction of heat from the warmer work area to the colder storage module. The thermal insulation requirements of the door are mitigated by the stepped control of temperatures between compartments of the invention. The door of the invention can also seal to prevent migration of gasses, e.g., water vapor, inert storage gasses, etc, between the work area and the storage module.

Transparent storage module doors are an aspect of the invention. Transparent doors allow an operator to view information displayed inside the modules, e.g., tray labels, tray location indicators 25, color codes, etc. With such information, an operator can move quickly to handle trays and minimize the amount of time the door is open during tray transfer operations. The stepped temperature and humidity control of the invention help prevent fogging and frosting of the door to maintain a clear view to the storage module interior. The transparent doors of the invention can be fabricated from any number of materials known in the art, such as glass, plastic, polycarbonate, and/or the like.

The racks of the invention can be enclosed within the storage module and contains slots adapted to receive sample trays. In a feature of the invention, the storage module door opens sufficiently to allow removal of the one or more racks for cleaning, maintenance, and the like. The rack can be configured to present information, e.g., bar code labels 27, tray location indicators, and color codes, which can be visible through a transparent storage module door.

The racks of the invention can have the slots organized in rows and columns for logical and compact storage of trays. For storage of trays of the invention holding microtiter plates, racks with 150 slots, e.g., having 5 columns and 30 rows, is a desirable configuration. Racks with, e.g., 10 to 50 rows and 4 to 6 columns and 40 to 300 slots are also useful configurations, among others. To simplify construction and reduce possibilities of icing, it is a feature of the invention for the slots to have lengthwise rails 26 (running, e.g., from the front to the back of the racks) to slidably receive the trays. One skilled in the art can readily determine operable rack configurations of slots in columns and rows given system requirements and constraints such as container size, tray size, storage module capacity, and the like.

A feature of the invention is a rack which presents information useful in identification of samples. For example, racks with slots in rows and columns allow ready identification of sample trays at tray locations designated by column number and row number. Trays, rack columns and rack rows can be color coded to speed tray transfers and prevent errors. Each column or row, with associated trays, can be coded with a unique color. Alternately, color combinations can be employed to convey more information. Tray location indicators 25 of the invention can be attached to the racks in association with trays in each slot and be actuated by computer commands to direct operators to tray locations of interest. Tray location indicators can be any signal capable of computer activation to direct an operator to a tray location, such as light emitting diodes, lights, buzzers, flags, alphanumeric dials, and the like. An aspect of the invention is the ability to view the information presented by the racks through the closed transparent storage module door. To avoid ambiguity, slots can each be labeled on two or more sides.

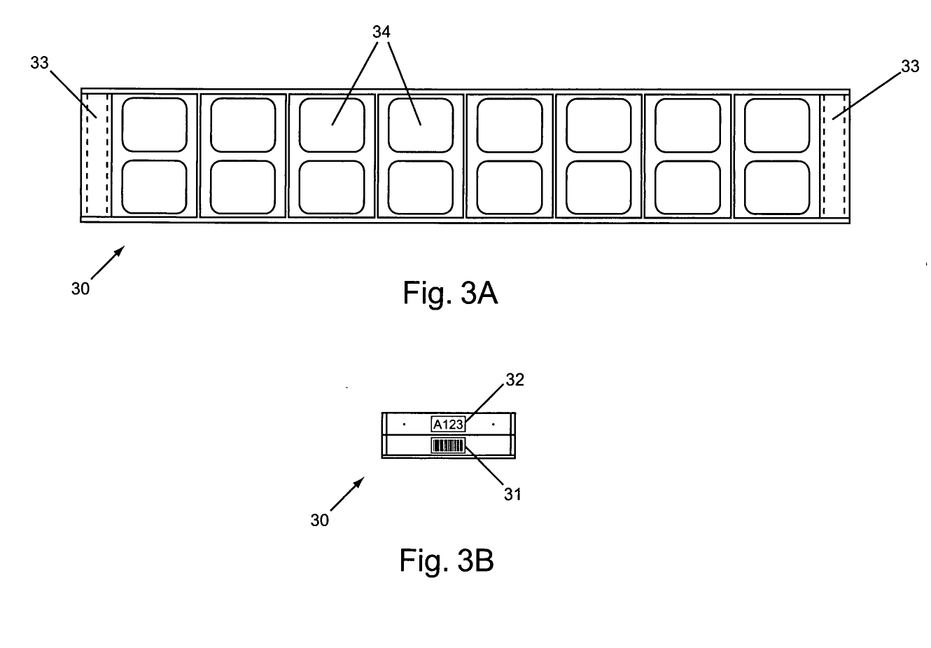

Trays of the invention can also be labeled to present information, e.g., tray location and tray identity, to the user. A feature of the invention can be trays 30 with bar code labels 31 (as shown in FIG. 3) for quick reliable identification of each tray and real time data entry to a computer. The trays can feature informative vision readable labels, e.g., color coded labels, and alphanumeric labels 32. For example, the front of each tray can have a color coded label corresponding to, e.g., a sample set or a column/row color coding scheme. Alphanumeric labels can present a broad range of tray information, e.g., tray number, column/row, sample identification, storage dates, storage conditions, project number and even plate database information, e.g., library name, a sub-group description, a mother/daughter plate designation, a plate type, a plate creation date, a plate location, a compound structure for each well, and/or a volume for each well.

Trays of the invention can be designed to conform to the special handling and materials requirements of the compound storage modules. An aspect of the invention is trays fabricated from rugged materials having low chemical reactivity, such polycarbonate and stainless steel. In one embodiment, the trays have handles 33 at each end to aid in operator handling. Trays can be constructed to hold a variety of compounds in a variety of sample containers conforming to the needs of the user. The trays can have nests 34 adapted to receive any of the above mentioned containers. For example, trays for microtiter plates can have 2-12 nests, 20 nests, and more. The trays can be adapted to hold a single deep microtiter plate in each nest, three standard microtiter plates stacked in each nest, or four shallow microtiter plates stacked in each nest, among other configurations.

Containers of the invention can include, e.g., tubes, bottles, culture dishes, vials, microtiter plates, and the like. Such containers can each have a unique bar-code label. The contents of the containers can be purified compounds or mixtures of compounds. Compounds held in the containers can include, e.g., chemical compound, biochemical compounds, nucleic acids, oligonucleotides, peptides, polypeptides, proteins, carbohydrates, cells, serum, phage particles, virions, enzymes, cell extracts, lipids, antibodies, synthetically modified peptides, and/or the like.

Microtiter plates are suitable to high throughput technology and compound library applications of the invention. Mother (master) plates of samples can be retained in deep 96-well plates. Several aliquots from mother plates can be prepared in shallow or 1536-well plates to avoid repeated freeze-thaw and handling of the mother plates. In one aspect, the invention provides storage of compounds in 96-well, 384-well, and 1536-well microtiter plates. Provision of bar code labels on the microtiter plates can make identification of plates and data acquisition easier and more reliable. Sealing the microtiter plates, e.g., with plastic covers or adhesive films, can prevent drying and eliminate sample cross contamination.

The compound storage system of the invention has the advantage of being capable of providing storage conditions of −20° C. to −55° C., and lower. Refrigeration systems, as described in “Environmental Controls” (supra), providing such temperatures in the storage module environment with a precision of plus or minus 2° C. are available, or can be produced by one of skill. Attaining such low temperatures and precision is made easier by the stepped control of temperature and physical barriers between compartments of the invention.

Computer Systems

Computer systems in the compound storage system can play many roles. The computer systems can acquire data, store data, and display data relevant to practice of the invention. The computer systems can provide instructions to operators, direction to the operators, or even exercise of physical control over operator actions. For example, operators can receive written instructions on a computer monitor, be directed to a tray of interest by illumination of tray location indicators, or receive permission to access a storage module by the computer disengaging a lock.

The computer system can interface with input devices and output devices, e.g., to monitor and control the storage system environments. For example, as shown in FIGS. 1 and 2, computer system 50 can receive input from operator keyboard 51, bar code reader 52, storage module temperature sensor 53, and the like. The computer system can provide output signals to lock 24, tray location indicators 26, robotic tray hander 54, computer monitor 55, and the like. I/O interfaces can communicate with input devices and/or output devices, e.g., through communication cables, radio communications, infrared light communications, and/or the like.

Systems in the present invention typically include a digital computer with data sets and instruction sets entered into a software system to practice the methods described herein. The computer can be, e.g., a PC (Intel ×86 or Pentium chip-compatible DOS™, OS2™ WINDOWS™ WINDOWS NT™, WINDOWS95™, WINDOWS98™ LINUX based machine, a MACINTOSH™, Power PC, or a UNIX based (e.g., SUN™ work station) machine) or other commercially common computer which is known to one of skill. Software for aligning or otherwise manipulating sequences is available, or can easily be constructed by one of skill using a standard programming language such as Visualbasic, Fortran, Basic, Java, or the like.

Any controller or computer optionally includes a monitor which is often a cathode ray tube (“CRT”) display, a flat panel display (e.g., active matrix liquid crystal display, liquid crystal display), or others. Computer circuitry is often placed in a box which includes numerous integrated circuit chips, such as a microprocessor, memory, interface circuits, and others. The box also optionally includes a hard disk drive, a floppy disk drive, a high capacity removable drive such as a writeable CD-ROM, and other common peripheral elements. Inputting devices, such as a keyboard or mouse, optionally provide for input from a user, and for user selection of sequences to be compared or otherwise manipulated in the relevant computer system.

The computer typically includes appropriate software for receiving user instructions, either in the form of user input into a set parameter fields, e.g., in a GUI, or in the form of preprogrammed instructions, e.g., preprogrammed for a variety of different specific operations. The software then converts these instructions to appropriate language for instructing, e.g., the sample handling operations.

Much of the data acquisition by the computer systems of the invention has to do with maintenance of an accurate sample inventory. When a change is made to a sample in the compound storage system, e.g., consumption of part of a sample, movement of a sample to a new storage location, removal of an entire plate of samples, and the like, the change can be documented in the inventory.

Inventory changes can be updated in the plate database of the invention through operator input devices such as manual data entry using a computer keyboard. Plate database information suitable for operator data entry includes, e.g., library names, sub-group descriptions, mother/daughter plate designations, plate types, compound structures, volumes removed per sample, volumes remaining per sample, and the like. Such data can be entered as a large batch of data in spreadsheet form. Alternately, such data can be entered in near real time on the operator's initiative or with computer prompting.

Inventory changes can also be updated to the plate database of the invention by scanning of bar code labels. Plate database information suitable for scanned data input includes, e.g., plate creation dates, plate locations, plate activity dates, and the like. Scanned data is often acquired real time and with high reliability.

Environmental information can be captured by data input sources and transmitted to the computer for storage or output. Such data includes, e.g., work area temperature, storage module temperature, work area oxygen level, storage module oxygen level, and the like. Instruments acting as data input sources can be simple, e.g., a thermistor providing direct analog input of an environmental temperature. More complex data input sources can be computerized instruments, e.g., analytical systems, in digital communication with the computer through the internet. Data acquisition can be continuous or intermittent depending on scientific and regulatory requirements. Thresholds, e.g., maximum temperatures or minimum oxygen levels, can be established provide an alarm warning an operator of an unsuitable or hazardous condition.

Data acquired by the computer can be stored in databases, e.g., as a record of the past environmental conditions or to establish the current status of an inventory. In one embodiment of the invention, a plate database is compiled to reflect the current status of the sample set in storage. The plate database can include, e.g., library names, sub-group descriptions, mother/daughter plate designations, plate types, plate creation dates, plate locations, compound structures for each well, volumes for each well, and the like. The mother plate history can additionally provide sampling information on the mother plate such as plate activity dates, the amount of samples removed, and the amount of samples remaining. A plate location of the invention can often be designated as the location of the tray in which it is stored. Stored data can be transmitted to output devices for viewing or analysis.

The computers of the compound storage and retrieval system provide data output useful to, e.g., inform an operator of system conditions, prompt an operator to take actions, supply system documentation, and prevent errors. Data output devices of the invention include, e.g., liquid crystal (LC) displays, computer monitors, printers, and command interface boards connected to, e.g., lights, locks and alarms.

Data output devices can inform an operator of system conditions. For example, a computer monitor or LC can display the temperature of the work area, the temperature of the storage module interior, the oxygen level of the work area, and storage module oxygen level. An operator can then respond if degrading conditions indicate a system maintenance problem. The operator might also simply note the storage module temperature has risen because it has been entered too often recently. The operator can decide to delay additional tray transfer operations until the storage temperature has had time to stabilize.

Data output consisting of procedural instructions for an operator is also a feature of the invention. The retrieval and storage methods, described herein, provide reliable sample handling and accurate inventories with careful attention to detail by the operator. Computer output of instructions and directions, e.g., tray identifications, tray locations, prompts to enter sample information, prompts to close a door, prompts to run maintenance procedures, and the like, help insure proper functioning of the system.

The computer system can transmit commands to take actions ensuring smooth operation of compound storage and retrieval system. The computer system can be operably coupled, through an interface, to physical actuators, e.g., door locks, lights and alarms, to provide certain notice of system requirements to the operator. The lockable doors of the storage modules can shut out operators to prevent retrieval or reloading of incorrect trays. Tray location indicator lights can be actuated by the computer system to designate what tray is to be retrieved or what slot is to receive a tray for reloading. The computer can actuate alarms to warn of, e.g., open doors, over temperature conditions, incorrect tray reloading, and the like.

The computer system is programmable to execute a set of instructions implementing the methods of the invention. For example, a computer system can be programmed to interact with an operator in a tray transfer operation as described below in the “Sample Loading and Retrieval” section below.

Sample Loading And Retrieval

The hardware and methods of the invention can provide rapid, accurate and well documented tray transfer operations. Tray transfers can be performed in a simple form, e.g., without redundant identification procedures or computer control commands, with satisfactory results. Users with more demanding reliability and accuracy requirements can employ more complex or redundant process steps of the invention to meet their needs.

Sample loading and sample retrieval procedures can be essentially the same in many embodiments of the invention. Typical procedures include, e.g., request for a tray, retrieval of a tray, addition or removal of samples, and reloading of the tray.

A representative example of a sample retrieval tray transfer operation is described below:

1) The operator enters a request at a computer keyboard to remove a set of compound samples from the storage system.

2) The computer searches a plate database to identify tray locations where the samples are in storage.

3) The computer displays the tray locations on a computer monitor and actuates a tray location indicator on a storage module rack to designate the first sample tray.

4) The computer terminates actuation of (unlocks) a lock on the door of the storage module to allow operator access to the first sample tray.

5) The operator opens the door and scans the bar code on the tray to be retrieved.

6) The computer compares the identification of the tray to the identification of the designated first sample tray to confirm the correct tray will be retrieved.

7) The operator manually retrieves the scanned tray by sliding the tray out of its slot.

8) The computer actuates the lock on the door.

9) The operator closes the door.

10) The operator removes the tray to a table in the work area and removes samples in a microtiter plate from the tray.

11) The operator scans a bar code on the microtiter plate removed from the tray.

12) The computer updates the plate database to reflect removal of the microtiter plate samples from the tray.

13) The operator enters a request at the computer keyboard to reload the tray into the storage module.

14) The computer terminates actuation of the lock on the appropriate door.

15) The operator opens the door and reloads the tray into the empty slot.

16) The operator scans the bar code on the reloaded tray and scans the associated tray location bar code.

17) The computer compares the identification of the reloaded tray to the tray location to confirm the tray has been reloaded to the correct tray location.

18) The computer terminates actuation of the location indicator light and actuates the door lock.

19) The operator closes the door.

20) If the initially requested sample set was stored in more than one tray, the process is repeated starting at step 3 until all samples in the set have been retrieved.

Robotic Sample Handling

The compound storage systems and methods of the invention are generally semiautomated. However, in one aspect of the invention, handling operations of a human operator to can be carried out by robotic systems. For example, robotic systems can be configured to open the door, scan the barcode on the tray, retrieve a tray from a slot, close the door, remove plates from trays, scan barcodes on plates, sip or pipette samples from plates or containers, and/or the like. The temperature and humidity controlled environments, e.g., of the work area, can enhance the reliability of mechanical and electronic parts of such systems.

Compound storage systems and methods can be fully automated, or further automated, by using robotic handling systems. Robotic systems can function in the temperature and humidity controlled work area with a low rate of malfunction. The robotic systems can be, e.g., computer-controlled, electric motor actuated, mechanical arms capable of movement in three dimensions (six degrees of freedom), and/or rotation in three dimensions while handling samples or system components. Such robotic arms can have ends (hands) adapted to grasp components of the system, such as trays, plates, doors, and/or the like. The robotic arms can have, e.g., sippers, pipettes, multi-pipettes, sampling pins, and/or the like, for transfer of samples between plates or to analytical instrumentation. Optionally, in another format, the robot can include a tray receiver with X-Y motion along the rows and columns of a storage module rack, and having a grasping mechanism adapted to interact with a tray handle to slide the tray in or out of its slot.

Many robotic systems are commercially available that can be adapted to compound storage systems of the invention. For example, a variety of automated systems are available from the Zymark Corporation (Zymark Center, Hopkinton, Mass.), which utilize various Zymate systems (see also, http://www.zymark.com/), which typically include, e.g., robotics and fluid handling modules. Similarly, the common ORCA® robot, which is used in a variety of laboratory systems, e.g., for microtiter tray manipulation, is also commercially available, e.g., from Beckman Coulter, Inc. (Fullerton, Calif.). Optionally, suitable robotic systems can be custom-designed and fabricated for particular compound storage systems, as is appreciated by those skilled in the art.

Compound Libraries

The compound storage and retrieval system of the invention excels at storage of large numbers of compounds, e.g., libraries of compounds subject to high throughput screening and analyses.

The libraries of compounds of the invention can be stored in any type of container appropriate to the circumstances. Microtiter plates in various formats, e.g., 96-well, 96-well, 384-well, 1536-well, deep, standard, shallow, are available and commonly used to store and handle compound libraries.

Containers held in trays of the intention can include, e.g., tubes, bottles, culture dishes, vials, and microtiter plates containing compounds, such as chemical compounds, biochemical compounds, nucleic acids, oligonucleotides, peptides, polypeptides, proteins, carbohydrates, cells, serum, phage particles, virions, enzymes, cell extracts, lipids, antibodies, synthetically modified peptides, and/or the like.

Libraries of gene sequences can be homologues of naturally occurring genes obtainable, e.g., by screening genomic or expression libraries according to any of a variety of well-established protocols, see, e.g., Ausubel et al. Current Protocols in Molecular Biology (supplemented through 2001) John Wiley & Sons, New York (“Ausubel”); Sambrook et al. Molecular Cloning—A Laboratory Manual (2nd Ed.), Vol. 1-3, Cold Spring Harbor Laboratory, Cold Spring Harbor, N.Y., 1989 (“Sambrook”), and Berger and Kimmel Guide to Molecular Cloning Techniques, Methods in Enzymology volume 152 Academic Press, Inc., San Diego, Calif. (“Berger”), additional variants can be produced by a variety of mutagenesis procedures. Many such procedures are known in the art, including site directed mutagenesis, oligonucleotide-directed mutagenesis, and many others. For example, site directed mutagenesis is described, e.g., in Smith (1985) “In vitro mutagenesis” Ann. Rev. Genet. 19:423-462, and references therein, Botstein & Shortle (1985) “Strategies and applications of in vitro mutagenesis” Science 229:1193-1201; and Carter (1986) “Site-directed mutagenesis” Biochem. J. 237:1-7. Oligonucleotide-directed mutagenesis is described, e.g., in Zoller & Smith (1982) “Oligonucleotide-directed mutagenesis using M13-derived vectors: an efficient and general procedure for the production of point mutations in any DNA fragment” Nucleic Acids Res. 10:6487-6500). Mutagenesis using modified bases is described e.g., in Kunkel (1985) “Rapid and efficient site-specific mutagenesis without phenotypic selection” Proc. Natl. Acad. Sci. USA 82:488-492, and Taylor et al. (1985) “The rapid generation of oligonucleotide-directed mutations at high frequency using phosphorothioate-modified DNA” Nucl. Acids Res. 13: 8765-8787. Mutagenesis using gapped duplex DNA is described, e.g., in Kramer et al. (1984) “The gapped duplex DNA approach to oligonucleotide-directed mutation construction” Nucl. Acids Res. 12: 9441-9460). Point mismatch repair is described, e.g., by Kramer et al. (1984) “Point Mismatch Repair” Cell 38:879-887). Double-strand break repair is described, e.g., in Mandecki (1986) “Oligonucleotide-directed double-strand break repair in plasmids of Escherichia coli: a method for site-specific mutagenesis” Proc. Natl. Acad. Sci. USA, 83:7177-7181, and in Arnold (1993) “Protein engineering for unusual environments” Current Opinion in Biotechnology 4:450-455). Mutagenesis using repair-deficient host strains is described, e.g., in Carter et al. (1985) “Improved oligonucleotide site-directed mutagenesis using M13 vectors” Nucl. Acids Res. 13: 4431-4443. Mutagenesis by total gene synthesis is described e.g., by Nambiar et al. (1984) “Total synthesis and cloning of a gene coding for the ribonuclease S protein” Science 223: 1299-1301. DNA shuffling is described, e.g., by Stemmer (1994) “Rapid evolution of a protein in vitro by DNA shuffling” Nature 370:389-391, and Stemmer (1994) “DNA shuffling by random fragmentation and reassembly: In vitro recombination for molecular evolution.” Proc. Natl. Acad. Sci. USA 91:10747-10751.

Many of the above methods are further described in Methods in Enzymology Volume 154, which also describes useful controls for trouble-shooting problems with various mutagenesis methods. Kits for mutagenesis, library construction and other diversity generation methods are also commercially available. For example, kits are available from, e.g., Amersham International plc (e.g., using the Eckstein method above), Anglian Biotechnology Ltd (e.g., using the Carter/Winter method above), Bio/Can Scientific, Bio-Rad (e.g., using the Kunkel method described above), Boehringer Mannheim Corp., Clonetech Laboratories, DNA Technologies, Epicentre Technologies (e.g., the 5 prime 3 prime kit); Genpak Inc, Lemargo Inc, Life Technologies (Gibco BRL), New England Biolabs, Pharmacia Biotech, Promega Corp., Quantum Biotechnologies, Stratagene (e.g., QuickChange™ site-directed mutagenesis kit; and Chameleon™ double-stranded, site-directed mutagenesis kit).

Numerous methods for producing polyclonal and monoclonal antibodies are known to those of skill in the art, and can be adapted to produce libraries of antibodies for storage in the systems of the invention. See, e.g., Coligan (1991) Current Protocols in Immunology Wiley/Greene, NY; and Harlow and Lane (1989) Antibodies: A Laboratory Manual Cold Spring Harbor Press, NY; Stites et al. (eds.) Basic and Clinical Immunology (4th ed.) Lange Medical Publications, Los Altos, Calif., and references cited therein; Goding (1986) Monoclonal Antibodies: Principles and Practice (2d ed.) Academic Press, New York, N.Y.; Fundamental Immunology, e.g., 4^{th} Edition (or later), W. E. Paul (ed.), Raven Press, N.Y. (1998); and Kohler and Milstein (1975) Nature 256: 495-497. Other suitable techniques for preparation of antibody libraries include preparation of recombinant antibodies in phage or similar vectors. See, Huse et al. (1989) Science 246: 1275-1281; and Ward, et al. (1989) Nature 341: 544-546.

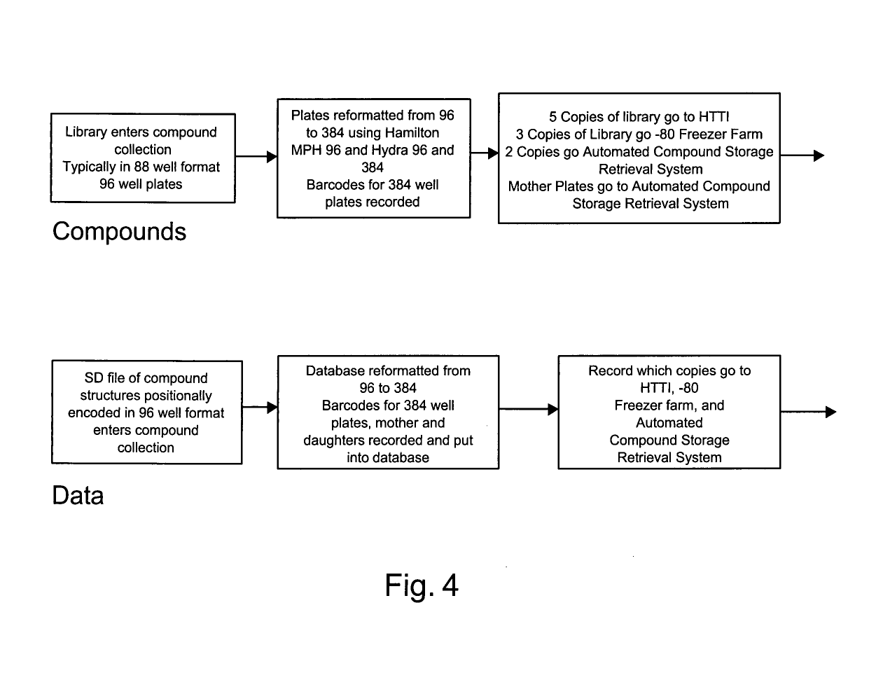

Compounds of the invention can be stored in an array. For example, cells can be arrayed by aliquoting into the wells of a multiwell plate, e.g., a 96, 384, 1536, or other convenient format selected according to available equipment. The arrayed cells can exposed to members of a composition library, and the cells sampled and monitored by, e.g., FACS, immunohistochemisty, ELISA, etc. Alternatively, nucleic acids or proteins can be prepared from the arrayed cells, in a manual, semi-automatic or automated procedure, and the products arranged in a liquid or solid phase array for evaluation. Additional details regarding arrays are provided above in the section entitled “Marker Sets.” Alternative high throughput processing methods, such as microfluidic devices, are also available, and can favorably be employed in the context of monitoring modulation of expression products. Physical storage and retrieval of compound libraries can be replicated in a parallel computer based data set, as shown in FIG. 4.

A cDNA library can be prepared by converting messenger ribonucleic acid (RNA) sequences back to deoxyribonucleic acid (DNA) sequences using the enzymatic action of reverse transcriptase. The resultant cDNA library is more stable than the original mRNA and avoids the issue of tRNA background. A cDNA library for a single cell type can be spread across various plates. Optionally, a library of cDNA libraries for many cell types can be stored as an array in plates of the invention. The relative quantitative sequence information of the original mRNA population is generally retained in a cDNA library. Several good cDNA analytical methods are known in the art including cDNA array technologies, subtractive cloning and massively parallel signature sequencing (MPSS). Quantitative gene expression data associated with nucleic acid sequence data can be compared between organisms with different phenotypes to identify differentially expressed genes enriched for phenotype controlling genes.

Microarrays are also technologies that can be applied in the context of the present invention. Typically, a microarray is a solid support that contains a variety of nucleic acids fixed to the support in a specified arrangement. mRNAs from a sample are allowed to hybridize to the microarray. Microarrays have the advantage of high throughput analysis of multiple samples. Typically, with microarray techniques, some or all of a variety of variables can be optimized. For example, genes of interest should have corresponding nucleic acids on a given array. Second, it is useful if a microarray already exists for an organism of interest. Third, detection sensitivity is typically optimized to achieve detection of genes expressed at low levels in the sample under investigation. Fourth, a sample is compared with a control sample to compensate for sources of bias and signal “noise.” Typically, the experiment is replicated several times to provide a more reliable data set. Fifth, the array can be designed to detect multiple regions for each gene of interest, because multiple signals can then be detected for, e.g., distinct probe regions within the gene. See also, Kerr and Churchhill, G. A., (2001), Statistical design and the analysis of gene expression microarray data, Biostatistics, 2:183-201; Wodicka et al., (1997), Genome wide expression monitoring in Saccharomyces cerevisiae, Nature Biotech., 15:1359-1367; Lockhart et al., (1996), Expression monitoring by hybridization to high-density oligonucleotide arrays, Nature Biotech., 14:1675-1680; Aach et al., Systematic management and analysis of yeast gene expression data, Genome Res., 10:431-445 and Wittes and Friedman, (1999) Searching for evidence of altered gene expression: a comment on statistical analysis of microarray data, J. Natl. Cancer Inst., 91:400-401.

More information regarding microarrays can be found in the following publications and references cited within: Duggan et al., (1999), Expression profiling using cDNA microarrays, Nature Genetics, 21:10-14; Lipshutz et al., High density synthetic oligonucleotide arrays, Nature Genetics Suppl. 21:20-24; Evertsz et al., (2000), Technology and applications of gene expression microarrays, in Microarray Biochip technology, Schena, M., Ed. BioTechniques Books, Natick, Mass., pp.149-166; Lockhart and Winzeler, (2000), Genomics, gene expression and DNA arrays, Nature, 405:827-836; Zhou et al., (2000), Information processing issues and solutions associated with microarray technology, in Microarray Biochip technology, Schena, M., Ed., BioTechniques Books, Natick, Mass., pp. 167-200; and Hughes et al., (2001), Expression profiling using microarrays fabricated by an ink-jet oligonucleotide synthesizer, Nature Biotech., 19:342-347.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A compound storage and retrieval system comprising:
(a) one or more storage modules comprising a lockable door controlling access to one or more racks, which racks comprise one or more slots, which slots receive one or more trays;
(b) a work area, providing operator access to the one or more storage modules; and,
(c) a computer system, operably coupled to the storage modules that implement one or more tray transfer operations between the storage module and the work area.

2. The compound storage and retrieval system of claim 1, wherein the work area has a low relative humidity.

3. The compound storage and retrieval system of claim 1, wherein the work area temperature is 1 to 8° C. and has a relative humidity of less than 40%.

4. The compound storage and retrieval system of claim 1, further comprising an antechamber comprising: operator access to the work area, a low relative humidity, and a temperature from 4° C. to 20° C.

5. The compound storage and retrieval system of claim 1, wherein the computer system transmits one or more commands directing function of a lock, which lock controls operator access to the storage module.

6. The compound storage and retrieval system of claim 5, wherein the lock comprises 100 pounds of magnetic locking force or more, and which lock is controllable by the computer system.

7. The compound storage and retrieval system of claim 1, wherein the computer transmits one or more commands directing actuation of one or more tray location indicators that direct an operator to a tray location of interest.

8. The compound storage and retrieval system of claim 1, wherein the lockable door opens sufficiently to allow removal of the racks.

9. The compound storage and retrieval system of claim 1, wherein the storage modules comprise an internal temperature of −20° C. or less.

10. The compound storage and retrieval system of claim 1, wherein the storage modules comprise temperature control at temperature settings ranging from about −20° C. to about −55° C.

11. The compound storage and retrieval system of claim 10, wherein the storage modules are temperature controlled to a precision within 2° C. of a desired temperature setting.

12. The compound storage and retrieval system of claim 1, wherein the racks comprise slots arranged in rows and columns.

13. The compound storage and retrieval system of claim 12, wherein the racks each comprise: 10 or more rows and 4 or more columns of slots.

14. The compound storage and retrieval system of claim 13, wherein the racks each comprise: 30 or more rows and 5 or more columns of slots.

15. The compound storage and retrieval system of claim 14, wherein the racks each comprise: 50 or more rows and 6 or more columns of slots.

16. The compound storage and retrieval system of claim 1, wherein the system comprises 40 or more slots.

17. The compound storage and retrieval system of claim 16, wherein the system comprises 100 to 300 slots.

18. The compound storage and retrieval system of claim 1, wherein the slots each comprise a unique bar code label.

19. The compound storage and retrieval system of claim 1, wherein the slots comprise one or more unique bar codes on two or more sides.

20. The compound storage and retrieval system of claim 1, wherein each slot is associated with one or more tray location indicators under control of the computer system.

21. The compound storage and retrieval system of claim 20, wherein the one or more tray location indicators comprises a light emitting diode, a light, a buzzer, a flag, or an alphanumeric indicator.

22. The compound storage and retrieval system of claim 1, wherein the slots comprise one or more lengthwise rails to slidably receive the trays.

23. The compound storage and retrieval system of claim 1, wherein the trays are adapted to receive one or more containers selected from the group consisting of: tubes, bottles, culture dishes, vials, and microtiter plates.

24. The compound storage and retrieval system of claim 23, wherein the microtiter plates comprise: 96-well plates, 384-well plates, or 1536-well plates.

25. The compound storage and retrieval system of claim 23, wherein the microtiter plates comprise one or more sample wells, and which microtiter plates comprise a seal over wells.

26. The compound storage and retrieval system of claim 23, wherein the containers each comprise a unique bar code.

27. The compound storage and retrieval system of claim 23, wherein the one or more containers comprise a plurality of compounds.

28. The compound storage and retrieval system of claim 27, wherein the plurality of compounds comprises: a chemical compound, a biochemical compound, a nucleic acid, an oligonucleotide, a peptides, a polypeptide, a protein, a carbohydrate, a cell, a serum, a phage particle, a virion, an enzyme, a cell extract, a lipid, an antibody, or a synthetically modified peptide.

29. The compound storage and retrieval system of claim 1, wherein the trays comprise 2 to 12 nests each of which are configured to hold one deep well microtiter plate, three standard microplates, or four shallow microplates.

30. The compound storage and retrieval system of claim 1, wherein the trays comprise polycarbonate.

31. The compound storage and retrieval system of claim 1, wherein the trays comprise one or more bar coded identification label.

32. The compound storage and retrieval system of claim 1, wherein the trays comprise one or more handles.

33. The compound storage and retrieval system of claim 1, wherein the trays comprise one or more alphanumeric label.

34. The compound storage and retrieval system of claim 1, wherein the trays comprise one or more color coded labels comprising: a unique color or a color combination corresponding to a particular column or row of slots.

35. The compound storage and retrieval system of claim 1, wherein the computer system comprises: one or more data input sources, one or more data storage locations, and one or more data output devices.

36. The compound storage and retrieval system of claim 1, further comprising a robotic system controlled by the computer.

37. The compound storage and retrieval system of claim 36, wherein the robotic system is configured to perform one or more operations selected from the group consisting of: opening the door, scaning barcodes on trays, retrieving the trays from the slots, closing the door, removing plates from the trays, scaning barcodes on plates, and sipping or pipetting a sample from plates or containers.

38. The compound storage and retrieval system of claim 35, wherein the data input sources comprise a bar code reader.

39. The compound storage and retrieval system of claim 35, wherein the data input sources comprise one or more operator input devices.

40. The compound storage and retrieval system of claim 35, wherein the data input sources transmit data to the computer, which data comprises: one or more of a work area temperature, a storage module temperature, a work area oxygen level, or a storage module oxygen level.

41. The compound storage and retrieval system of claim 35, wherein the data storage locations comprise a plate database.

42. The compound storage and retrieval system of claim 41, wherein the plate database comprises data selected from the group consisting of a library name, a sub-group description, a mother/daughter plate designation, a plate type, a plate creation date, a plate location, a compound structure for each well, and a volume for each well.

43. The compound storage and retrieval system of claim 42, the plate database further comprising a mother plate history comprising one or more of a plate activity date, a volume removed per sample and a volume remaining per sample.

44. The compound storage and retrieval system of claim 42, wherein the plate location comprises a tray location.

45. The compound storage and retrieval system of claim 35, wherein the data output devices display one or more of a work area temperature, a storage module temperature, a work area oxygen level or a storage module oxygen level.

46. The compound storage and retrieval system of claim 35, wherein the data output devices display one or more instruction for an operator.

47. The compound storage and retrieval system of claim 46, wherein the data output devices comprise a computer monitor.

48. One or more library of compounds stored in the compound storage and retrieval system of claim 1.

49. A compound storage module comprising:
(a) one or more racks; which racks comprise one or more slots arranged in rows and columns within the racks;
(b) one or more transparent lockable doors associated with the racks; which doors control access to the racks; and,
(c) a plurality of tray location indicators coupled to the racks; wherein one or more tray location indicators are associated with each slot;
wherein the storage module is a temperature controlled storage module, which temperature is −20° C. to −55° C.

50. The compound storage module of claim 49, wherein the storage module comprises the racks, which racks comprise the slots, which slots receive one or more trays, which trays comprise one or more plates, which plates comprise a plurality of samples.

51. A method of controlling retrieval and storage of a plurality of compounds, the method comprising:
(a) identifying a tray location for a requested tray in a storage module, which storage module comprises a plurality of slots, which slots each receive a tray, wherein each tray has a unique identity, wherein one or more trays comprise the plurality of compounds;
(b) designating the tray location for the requested tray;
(c) directing unlocking of a door controlling access to the storage module associated with the designated tray location;
(d) confirming the identity of the requested tray on retrieval of the requested tray from the storage module; and,
(e) confirming the identity and the tray location of the requested tray upon reloading of the requested tray into the storage module, thereby controlling the retrieval and storage of the plurality of compounds from the storage module.

52. The method of compound retrieval and storage of claim 51, further comprising repeating steps (a) to (e) for a one or more additional requested trays.

53. The method of compound retrieval and storage of claim 51, further comprising computerized implementation of the identification in step (a), the designation in step (b), the directing in step (c), the confirmation in step (d), or the confirmation in step (e).

54. The method of compound retrieval and storage of claim 51, wherein identification of tray location in step (a) comprises comparing an operator compound sample request with a plate database.

55. The method of compound retrieval and storage of claim 51, wherein designation of the tray location in step (b) comprises a computer command directing actuation of one or more tray location indicators at the tray location.

56. The method of compound retrieval and storage of claim 51, wherein said unlocking comprises actuating or de-energizing: an electromagnet or solenoid.

57. The method of compound retrieval and storage of claim 55, wherein the actuation of the tray location indicator is cancelled when reloading of the tray is confirmed in step (e).

58. The method of compound retrieval and storage of claim 51, wherein step (d) comprises scanning a bar code on the tray.

59. The method of compound retrieval and storage of claim 51, wherein step (e) comprises scanning a bar code on the tray and scanning one or more bar codes at the tray location.

60. The method of compound retrieval and storage of claim 51, further comprising a computer command directing unlocking of the door controlling access to the storage module associated with the tray location designated in step (b) only if all slots in the storage module contain a tray.

61. The method of compound retrieval and storage of claim 51, comprising locking the door at the storage module associated with the tray location on confirmation of tray identify on retrieval and unlocking of the door after a request to reload the tray, which locking and unlocking are computer directed.

62. The method of compound retrieval and storage of claim 61, wherein the computer command which directs unlocking of the door is suspended until a plate database is updated to reflect one or more changes to one or more plates in the tray.

63. The method of compound retrieval and storage of claim 51, wherein a computer command directs locking of the door on confirmation of tray identity and tray location.

64. The method of compound retrieval and storage of claim 51, wherein the trays comprise one or more plates, and further comprising updating a plate database to reflect one or more changes in the plates.

65. The method of compound retrieval and storage of claim 64, wherein updating the plate database comprises scanning of one or more plates, which one or more plates are added or removed from the tray.

66. The method of compound retrieval and storage of claim 64, wherein the plate database is updated by operator input of data.

67. The method of compound retrieval and storage of claim 64, wherein the plate database is updated concurrent with the tray being retrieved from the tray location.

68. A method of controlling sample retrieval and storage, the method comprising:
(a) requesting a sample to be retrieved from a storage module, which request comprises input to a computer system, which computer system comprises a plate database of sample information, which computer system is operably linked to a storage module, which storage module comprises a plurality of samples;
(b) searching the plate database for the requested sample, thereby identifying a tray location for the sample in the storage module;
(c) directing actuation of one or more tray location indicators associated with a slot position at the tray location, thereby designating the tray location;
(d) directing unlocking of a door controlling access to the storage module associated with the designated tray location;
(e) scanning a bar code on the tray, and confirming a tray identity on retrieval of the tray;
(f) updating the plate database to reflect one or more changes in the sample information; and,
(g) scanning the bar code on the tray and scanning one or more bar codes at the tray location, and confirming the tray identity and the tray location upon reloading the tray into the storage module, thereby controlling retrieval and storage of the sample.
